(19) United States
(12) Patent Application Publication
(10) Pub. No.: US 2008/0105797 A1
(43) Pub. Date: May 8, 2008

(54) CURVED RETRACTABLE BANNER STAND

(75) Inventors: Mark A. Fritsche, Eagan, MN (US); John T. Elliott, Eagan, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: SKYLINE DISPLAYS, INC., Eagan, MN (US)

(21) Appl. No.: 11/926,949

(22) Filed: Oct. 29, 2007

Related U.S. Application Data
(60) Provisional application No. 60/863,293, filed on Oct. 27, 2006.

(51) Int. Cl. F16M 11/00; G09F 15/02

(52) U.S. Cl. 248/161; 40/606.01

(57) ABSTRACT

A banner stand having a banner having generally opposed major surfaces, the banner having graphics presented with at least one of the major surfaces. The banner stand further includes a base and a post extending upwardly from the base, the post operably supporting the banner when the banner is in an upright mode. The banner stand also including a curved form having a curved surface for operably supporting the banner in a curved shape, and a retaining portion presented with the curved surface, the retaining portion having an operable surface engageable with at least one of the major surfaces to retain the banner in the curved shape. The operable surface provides a coefficient of friction between the banner and the operable surface that is greater than a coefficient of friction between the banner and the curved surface without the retaining portion.

### RELATED APPLICATION

The present application claims the benefit of U.S. Provisional Application No. 60/863,293, filed Oct. 27, 2006, which is incorporated herein in its entirety by reference.

### FIELD OF THE INVENTION

The present application relates generally to tradeshow displays. More particularly, the embodiments of the present application relate to tradeshow displays, such as banner stands, having a retaining member or portion presented therewith for maintaining the display in an open, curved configuration.

### BACKGROUND OF THE INVENTION

Trade show displays are often collapsible and can be easily transported and erected. Such displays can also divide spaces and present visual graphics for viewing by attendees. One pleasing aspect of such displays is the ability to provide some depth, such as providing a smooth-flowing, curved display surface. One structure used at trade shows includes a network of support rods that expand into a volumetrically substantial three-dimensional space. Such expanded structures can then be covered with sheet material capable of supporting graphics. For example, see U.S. Pat. No. 4,658,560. These displays can provide an attractive smooth curved surface for the graphics.

Other types of collapsible displays include banner stands. These stands are often used in reception areas, trade shows, museums, art exhibits, academic and research society meetings, advertising displays, and other areas in which visual information is temporarily displayed. Examples of such banner stands are illustrated in U.S. Pat. Nos. 6,571,496 and D468,362, U.S. Patent Publication 2002/0050083, and PCT Publication Nos. WO 01/91092, WO 01/35381, and WO 00/47508. To give the retractable banner stands depth, those using the banner stands often arrange and connect a series of banner stands. When arranged in this manner, the series creates a multi-faceted display, each facet containing a portion of an overall display. However, the flat display nature of retractable banners can present an awkward looking graphic, particularly where an image is continuous between the adjacent facets.

There is therefore a need for a tradeshow display including a mechanism to impart a smooth curve to the banner, yet wherein any bunching of the banner is inhibited or prevented.

### BRIEF SUMMARY

The tradeshow displays, including banner stands, according embodiments include a retaining member or portion that inhibits the tendency of a banner on a banner stand with a curvature mechanism to bunch up towards the middle of the one or more curved forms. The retaining member or portion or coating can be disposed, for example, on the curved surface of the elongate forms and can frictionally or otherwise engage a portion, such as an inner surface, of the banner to inhibit the tendency of the banner to bunch up.

In an embodiment, a banner stand having an erected upright mode and a collapsed transport mode includes a banner having generally opposed major surfaces thereon, the banner having graphics thereon, a base and a post extending upwardly from the base, a cross member presented with the post to support the banner when the banner is in an upright mode, a curved form having a curved surface thereon for operably supporting the banner in a curved configuration, and a retaining portion presented with the curved surface, the retaining portion having an surface thereon engageable with one of the major surfaces to retain the banner in the curved configuration.

In an embodiment, a method of providing a banner and retaining the banner in an open, curved configuration includes providing a banner having generally opposed major surfaces and being formed of a flexible sheet, providing a curved form having a curved surface thereon and presenting a retaining member on the curved surface, the retaining member having an operable surface thereon, and utilizing the curved form to support the banner in an open, curved configuration, wherein the operable surface of the retaining member engages with at least one of the major surfaces of the banner to retain the banner in the open, curved configuration.

In another embodiment, a tradeshow display includes a sheet having generally opposed major surfaces, curved means having a curved surface thereon for supporting the sheet in an open, curved configuration, and retaining means presented on the curved surface, the retaining means having an operable surface thereon engageable with one of the major surfaces to frictionally retain the banner in the open, curved configuration.

### BRIEF DESCRIPTION OF THE DRAWINGS

FIG. 1 is a front perspective view of a retractable banner stand according to a first embodiment depicting a banner, base, and cross member;

FIG. 2 is a rear perspective view of the retractable banner stand of FIG. 1, further depicting a post;

FIG. 3 is a bottom fragmentary rear perspective view of a banner of a retractable banner stand;

FIG. 4 is a top fragmentary rear perspective view of the banner of FIG. 3;

FIG. 5 is a close-up side elevation view of a core of a retractable banner stand having a banner coupled thereto;

FIG. 6 is a rear perspective view of the base of the retractable banner stand of FIG. 1, depicting feet in an open configuration;

FIG. 7 is a front perspective view of the base of the retractable banner stand of FIG. 1, depicting the feet in a closed configuration;

FIG. 8 is a perspective view of the core of FIG. 5;

FIG. 9 is a fragmentary rear perspective view of a retractable banner stand according to a second embodiment;

FIG. 10 is a close-up fragmentary side perspective view of a base of a retractable banner stand;

FIG. 11 is a top view of the base of a retractable banner stand depicting a mechanism for providing curvature to the banner according to a first embodiment;

FIG. 12 is a bottom fragmentary rear perspective view of a banner stand according to a first embodiment;

FIG. 13 is a bottom fragmentary rear perspective view of a banner according to a second embodiment;

FIG. 14 is a fragmentary top rear perspective view of a retractable banner stand;

FIG. 15 is a fragmentary bottom rear perspective view of a retractable banner stand;

FIG. 16 is a top view of the base of a retractable banner stand depicting a mechanism for providing curvature to the banner according to a second embodiment;

FIG. 17 is a fragmentary bottom rear perspective view of a banner;

FIG. 18 is a fragmentary bottom rear perspective view of a retractable banner stand;

FIG. 19 is a top view of the base of a retractable banner stand depicting a mechanism for providing curvature to the banner according to a third embodiment.

FIG. 20 is a fragmentary top rear perspective view of the retractable banner stand of FIG. 17;

FIG. 21 is a fragmentary top rear perspective view of a retractable banner stand according to another embodiment;

FIG. 22 is a rear perspective view of the retractable banner stand;

FIG. 23 is a perspective view of a plurality of retractable banner stands arranged in a series;

FIG. 24 is a schematic illustration depicting a banner stand in various stages of assembly;

FIG. 25 is a fragmentary bottom rear perspective view of a retractable banner stand, depicting a central portion of a base strip having a curve imparted thereto;

FIG. 26 is a top view of the base of a retractable banner stand depicting a mechanism for providing curvature to the banner according to a fourth embodiment;

FIG. 27 is a fragmentary bottom rear perspective view of a retractable banner stand;

FIG. 28 is a perspective view of a plurality of retractable banner stands arranged in a series;

FIG. 29 is a top view of the series of FIG. 28;

FIG. 30 is a top view of the base of a retractable banner stand depicting a mechanism for providing curvature to the banner according to a fifth embodiment;

FIG. 31 is a fragmentary side perspective view of a retractable banner stand depicting a retaining member presented proximate an end of a curved form of the banner stand;

FIG. 32 is a top plan view of the retractable banner stand of FIG. 31;

FIG. 33 is a close-up top plan view of the retaining member presented with the curved form;

FIG. 34 is a close-up top plan view of the retaining member presented with the curved form depicting a banner operable with the retaining member;

FIG. 35 is a front elevational view of the retaining member presented with the curved form depicting a banner operable with the retaining member, wherein the retaining member and a portion of the curved form are depicted in phantom lines;

FIG. 36 is a close-up top plan view of the retaining member presented with a surface of the banner and operable with the curved form;

FIG. 37 is a top plan view of the retaining member, wherein portions of a retaining member are presented with each of the banner and curved form are partially operable with one another;

FIG. 38 is a top plan view of the retaining member of FIG. 37, wherein the portions of the retaining member are operable with one another; and

FIG. 39 is a fragmentary front perspective view of an embodiment of a retaining member, wherein the retaining member is formed on a curved surface a curved.

### DETAILED DESCRIPTION OF THE DRAWINGS

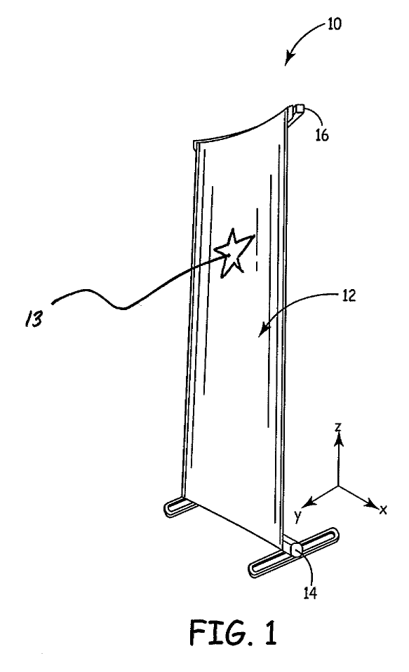

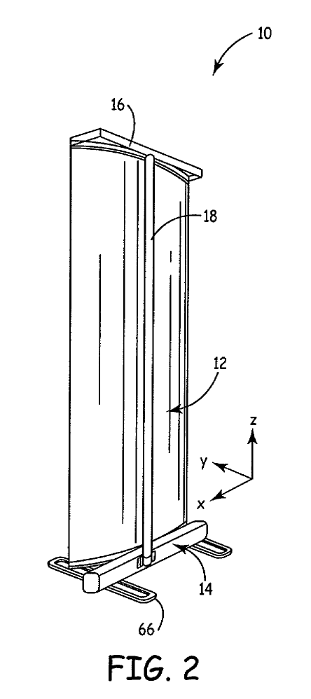

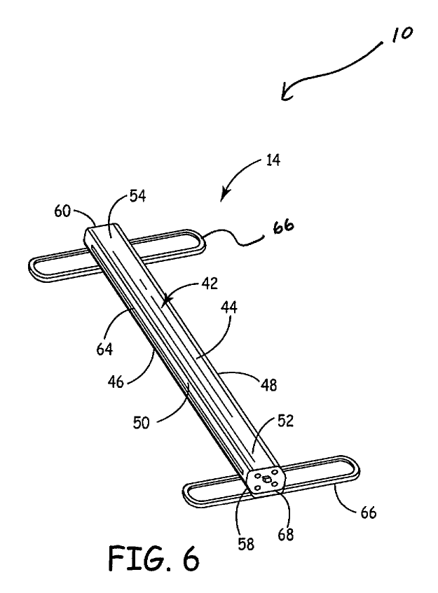

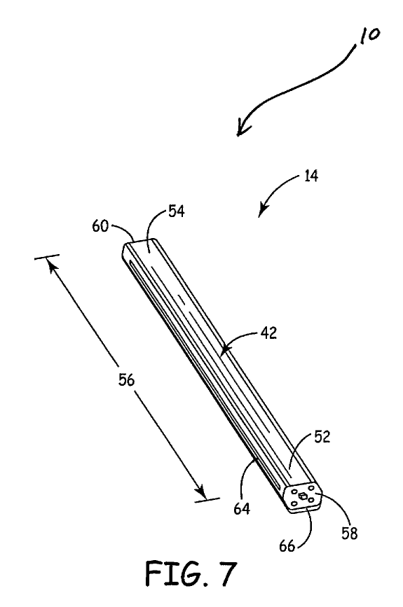

As can be seen in FIGS. 1-2, a retractable banner stand 10 generally comprises a banner 12 having graphics 13, a base 14, and a post 18 (FIG. 2) having a cross member 16 thereon. While the retractable banner stand 10 in FIGS. 1-2 is depicted in a fully dispensed or erected, upright mode, a retractable banner stand 10 in a fully retracted or collapsed transport mode can be seen in FIGS. 6-7.

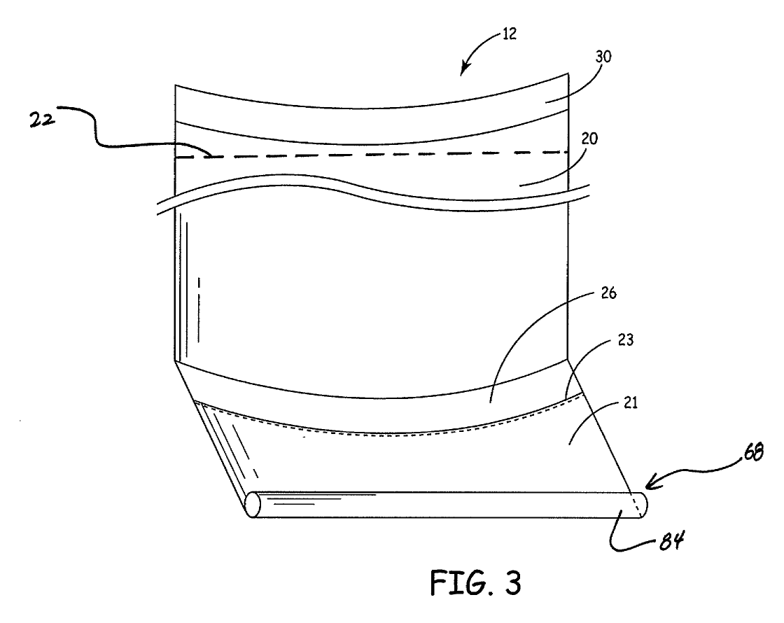

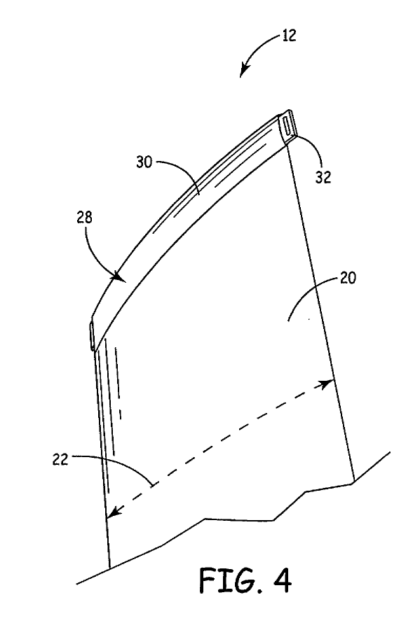

As depicted in FIGS. 3-5, the banner 12 can comprise a sheet 20 having a banner width 22, a leader or lead-in portion 21 connected to a bottom end 26 of the sheet 20 at a junction 23, an exchange member 24 connected to the leader 21 opposite the junction 23, and a header 28 located on the sheet 20 opposite the bottom end 26. The banner 12 can further include a pocket 30 proximate the header 28 and a top strip 32 slidably engaging and fitting within the pocket 30.

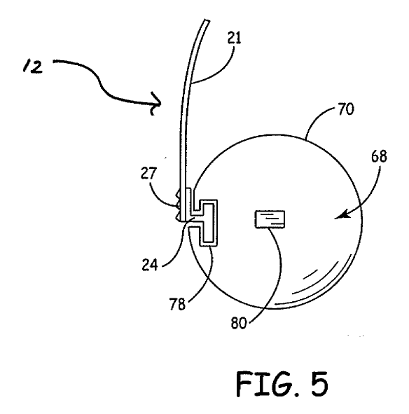

The sheet 20 can be fabricated using a flexible-foldable material such poplin, but can also be made out a number of materials including, but not limited to, various textiles, polyplastic, and LYCRA®. The leader 21 can be fabricated using a stretchable material such as LYCRA®, but can be made out a number of materials. The leader material can be more stretchable than the banner material by more than 20% and has a warp stretch between 135 and 165 at 30 lbs The leader material can include a side stretch between 70 and 90 at 30 lbs. These stretch values are obtained using a stretch test performed per ASTM D4964. While the banner 12 can comprise a stretchable leader 21, it is contemplated that the sheet 20 be fabricated using a stretchable material such as LYCRA®, the sheet being connected to the exchange member 24 at the bottom end 26, thus eliminating the need for a leader 21. While the sheet 20 can be made out a stretchable material such as LYCRA®, those skilled in the art recognize that it can be made out of a number of other materials. The exchange member can be constructed of plastic, but can be made out of, for example, steel, extruded aluminum, or other materials. While the exchange member 24 as depicted in FIG. 5 is connected to the leader 21 using stitches 27, the exchange member 24 can be connected to the sheet 20 by any number of means, including, but not limited to, tape, rivets, staples, or screws.

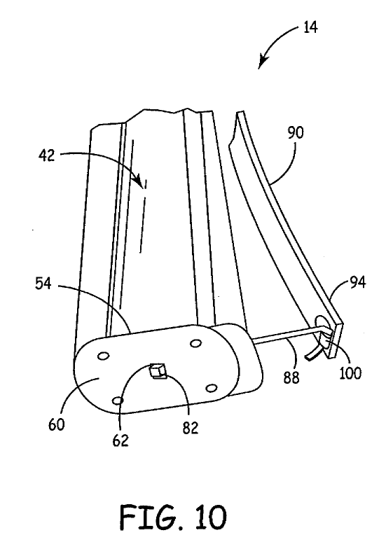

As depicted in FIGS. 6-7, the base 14 can comprise a housing 42 comprising a top 44, a bottom 46, a front 50, and a rear 48. The housing 42 further comprises a first housing end 52 and a second housing end 54, the distance between the housing ends 52, 54 defining a housing width 56 (FIG. 7). The housing 42 is enclosed at the first housing end 52 by a first plate 58 and at the second housing end 54 by a second plate 60, the plates 58, 60 being connected to the housing 42 using screws. Alternatively, the plates 58, 60 can be connected to the housing 42 using bolts, rivets, snaps, or weldaments. As can be seen in FIG. 10, the plates 58, 60 each can include a tab aperture 62. The housing 42 further includes a banner slot 64 extending substantially from the first housing end 52 to the second housing end 54. The housing can be constructed of extruded aluminum, but can be made out a number of materials including, but not limited to, sheet metal or various polymers.

The base 14 can comprise at least one foot 66 for stabilizing the retractable banner stand 10. As depicted in FIG. 7, when the retractable banner stand 10 is not in use and in a fully retracted position, the at least one foot 66 is arranged so that it is substantially parallel the housing 42. Once the retractable banner stand 10 is in use and in a dispensed position, the at least one foot 66 is arranged so that it is substantially perpendicular the housing 42, as depicted in FIG. 6. In this position, the at least one foot 66 gives stability to the retractable banner stand 10. The feet 66 contact the floor surface or tabletop surface. Such feet can be removable or pivotal for folding up the base for transportation and storage. The at least one foot 66 can be snapped, pivoted, or slid onto the ends 52, 54 of the housing 42.

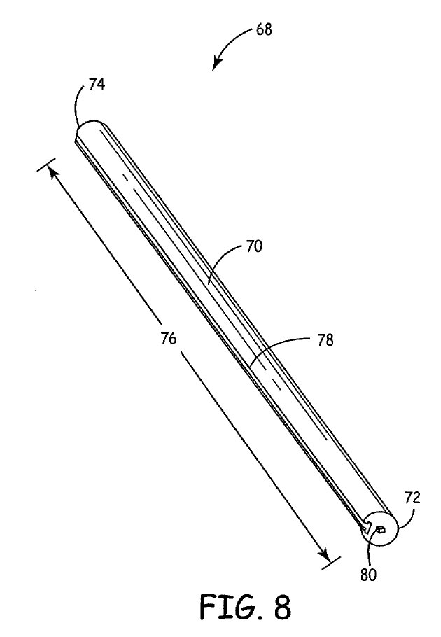

The base 14 further comprises a retractor mechanism 68 as depicted in FIGS. 5 and 8. The retractor mechanism 68 can comprise a core 70, a first retractor end 72, and a second retractor end 74, the distance between the ends defining a retractor width 76. The retractor mechanism can be spring loaded and utilizes componentry not shown herein in detail but well known in the art. See, for example, U.S. Pat. No. 6,571,496 incorporated herein by reference in its entirety. The retractor width 76 can be substantially equal to the housing width 56 and slightly larger than the banner width 22. The core 70 comprises a channel 78 can extend from the first retractor end 72 to the second retractor end 74. The retractor mechanism 68 also can comprise a first tab 80 extending beyond the first retractor end 72 and a second tab 82 extending beyond the second retractor end 74. The tabs 80, 82 can be slightly smaller in size than the tab aperture 62.

As depicted in FIG. 5, the leader 21 or sheet 20 can be connected to the retractor mechanism 68 by first slidably engaging the exchange member 24 with the channel 78. Once the exchange member 24 engages the channel 78, the sheet 20 can then be wound onto the core 70 creating a banner roll 84 (FIG. 3), which has a round profile. The channel 78 can comprise a retaining feature to retain the exchange member 24 from slipping out of the core 70 when there is no load on the retractor 68. It is also contemplated that the bottom end 26 of the banner includes an exchange member made of the leader 21. The leader 21 would slidably engage with the channel 78 in order to connect the banner 12 to the retractor 68 in an alternative manner.

The leader 21 can be connected directly to the core 70. The banner 12 can comprise an exchange member 24 having a first exchange member portion and a second exchange member portion. The first exchange member portion is connected to the leader 21 opposite where the leader 21 is connected to the core 70. The second exchange member portion is connected to the sheet 20 opposite the header 28. When one using the retractable banner stand 10 desires to change the sheet 20, she simply slides apart the two exchange member portions and inserts a new sheet 20 having a second exchange member portion. Once sheet 20 has been rolled into the banner roll 84, the banner roll 84 can be placed through an access aperture located on at least one of the first plate 58 or second plate 60 and positioned inside of the housing 42 until the first tab 80 slidably engages with the tab aperture 62 on the plate opposite the plate in which the access aperture is located. Once the first retractor end 72 abuts the plate, the access aperture is enclosed so that the second tab 82 is captured by the tab aperture 62 on the plate comprising the access aperture.

If at least one of the first plate 58 or second plate 60 does not include an access aperture, the housing 42 can include an access door on the top 44, bottom 46, front 50, or rear 48 in which the banner roll 84 can be inserted into the housing 42. When the banner roll 84 is placed into the housing 42, the sheet 20 is positioned such that header 28 is located outside of the housing 42 while the remainder of the banner roll 84 is located within the housing 42. By being larger than the banner slot 64, the top strip 32 can inhibit the header 28 from being wound onto the banner roll 84 once the banner roll 84 is inserted into the housing 42. The retractor 68 can further comprise a winding mechanism for winding and unwinding the banner 12 with respect to the core 70. Such a winding mechanism is shown and described in PCT Publication No. WO 00/47508, incorporated herein by reference in its entirety.

Because a retractable banner stand 10 can include an access aperture or other access door, users can change the a banner 12 on a banner roll 84 without having to remove or move anything on the base 14, with the exception of the retractor 68. This enables users to quickly change any graphics on the retractable banner stand 10 if they desire doing so.

When one desire to use the retractable banner stand 10, the post 18 and cross member 16 can be assembled and connected before the banner 12 can be dispensed. The post 18 is first connected to the housing 42 intermediate the first housing end 52 and second housing end 54 such that the post 18 is perpendicular the housing 42. The cross member 16 is then connected to the post 18 so that the cross member 16 is generally perpendicular to the post 18 and substantially parallel to the housing 42. While the post 18 can be made of an integral, unitary section, it is contemplated that the post 18 comprises more than one section so that it can be adjusted in height and can be dissassembled. In addition, while the post 18 and cross member 16 can be separate but connectable, it is contemplated that the post 18 and cross member 16 be connected using a pin or hinge (not depicted in figures). Once the post 18 is connected to the housing 42, the cross member 16 can be rotated or hinged so that it is perpendicular to the post 18. Once the post 18 and cross member 16 are assembled and connected, the banner 12 can be dispensed from the retractor 68 until the top strip 32 or header 28 can be connected to the cross member 16. The top strip 32 or header 28 can be connected to the cross member 16 using a hook, snap, magnetic strips, screws, bolts, slot & groove, or hook and loop material such as VELCRO®.

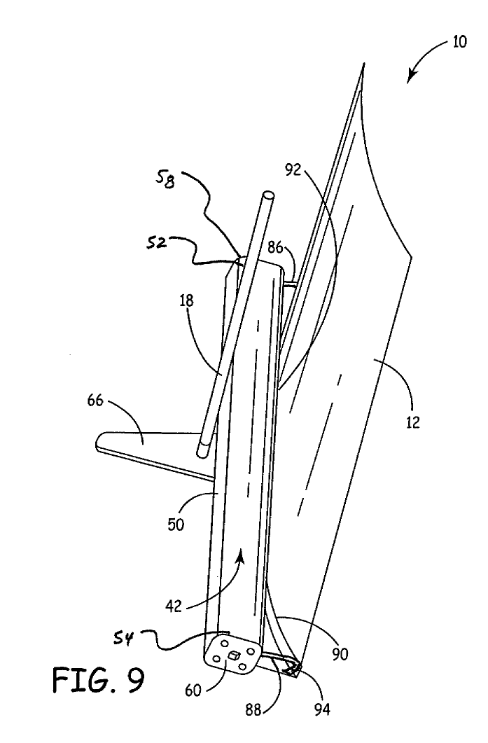

The retractable banner stand 10 comprises various curved forms and curvature means for providing curvature to the banner 12. As depicted in FIGS. 9-11, a retractable banner stand 10 comprises a first base spacer 86 hingedly connected to the housing 42 proximate the first housing end 52 and a second base spacer 88 hingedly connected to the housing 42 proximate the second housing end 54. Alternatively, the first base spacer 86 can be hingedly connected to the first plate 58 and the second base spacer 88 hingedly connected to the second plate 60. The base 14 can comprise a base strip 90 comprising a first strip end 92, second strip end 94, and base strip center 96. Also, the base strip center 96 can be connected to the front 48 of the housing 42 intermediate the first plate 58 and second plate 60.

The base strip 90 can comprise a cross-section with a greater dimension in a first plane and a lesser dimension in a second plane that is perpendicular to the first plane. The greater dimension can be at least four times the lesser dimension whereby the base strip 90 is more readily flexible in the plane of the lesser dimension and wherein the plane of the lesser dimension is substantially horizontal when the retractable banner stand 12 is erected into the upright mode. While the base strip 90 has been described as having a greater dimension in a first plane and a lesser dimension in a second plane that is perpendicular to the first plane, the base strip can also be a rod, cylinder, or wire.

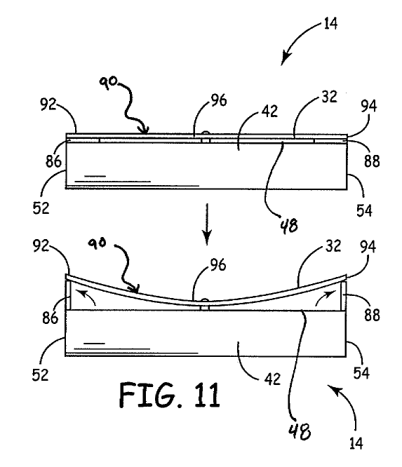

Referring to FIG. 11, when the banner 12 is in a fully retracted position, the base spacers 86, 88 can be folded inward towards a position intermediate the first housing end 52 and second housing end 54 so that the base spacers 86, 88 abut the housing 42. When the base spacers 86, 88 are in this position, the base strip 90 is in a non-use position and remains unstressed and is in a substantially unflexed shape.

When the banner 12 is in a fully dispensed position, as depicted in FIG. 9, the base spacers 86, 88 can be displaced hingedly outward to a position substantially perpendicular with the front of the housing 48. Once the base spacers 86, 88 are in this position, the first base spacer 86 engages a first eyelet 98 connected to the first base strip end 92 and the second base spacer 88 engages a second eyelet 100 connected to the second base strip end 94. Because the base strip center 96 can be connected to the housing 42, the base strip 90 is in a curved use position and is given a flexed, curved shape or form, as can be seen in FIG. 9. Alternatively, the base spacers 86, 88 can slide into a slot in the base housing 42 and then be connected to the slot in the base housing 42. Alternatively, the base spacers 86, 88 can hinge downwardly or upwardly to a position generally perpendicular with the front of the housing 48.

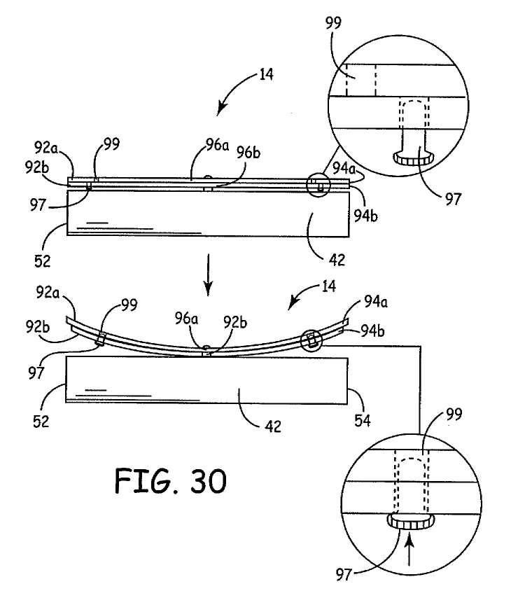

As depicted in FIG. 30, the mechanism for imparting a curve on a banner is similar to a “leaf-spring” mechanism. The base strip 92 comprises a first base strip member 92a and a second base strip member 92b. When the second base strip member 92b is given a flexed shape, it slides along and imparts a curve on the first base strip 92a. In order to retain the first base strip member 92a and second base strip member 92b in the flexed shape, the base strip 92 can comprise tabs 97, on the second base strip member 92b. Once the first and second base strips member 92a, 92b are given the flexed shape, the tabs 97 will engage with apertures 99 that are included on the first base strip member 92a. Alternatively, the tabs 97 can be included on the first base strip member 92a and the apertures 99 on the second base strip member 92b. When the tabs 97 engage with the apertures 99, the first and second base strip members 92a, 92b are retained in the flexed shape. To remove the first and second base strip members 92a, 92b from the flexed shape, the tabs 97 are disengaged with the apertures 99 so that the first and second base strip members 92a, 92b can return to an unflexed shape. The tabs 97 can include biasing means such as a spring so that they are biased towards the aperture 99 or can alternatively frictionally fit within the second base strip member 92b and manually slide into the aperture 99.

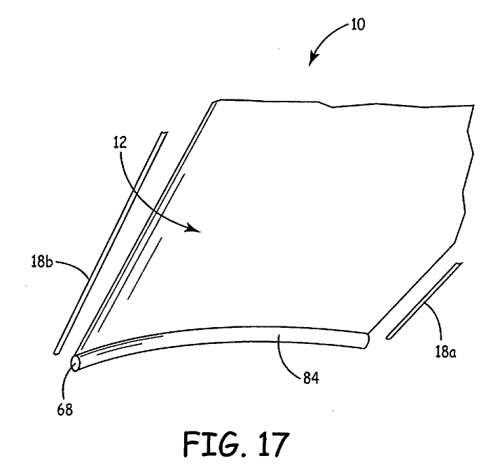

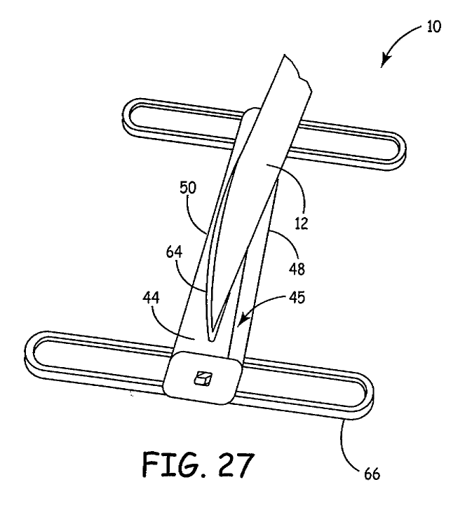

As depicted in FIG. 27, the banner slot 64 is generally curved and is located on the top, of the housing 42. When the banner 12 is retracted from the retractor mechanism 68, the slot 64 imparts a curve on the banner 12. While the retractor mechanism 68 might not be curved, it is contemplated that the retractor mechanism 68 be curved as depicted in FIG. 17.

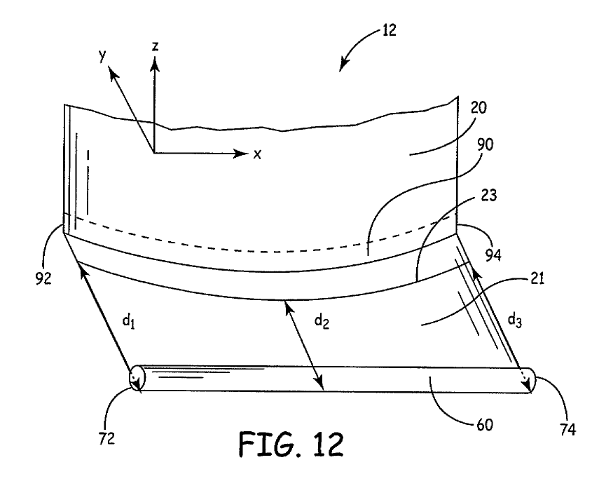

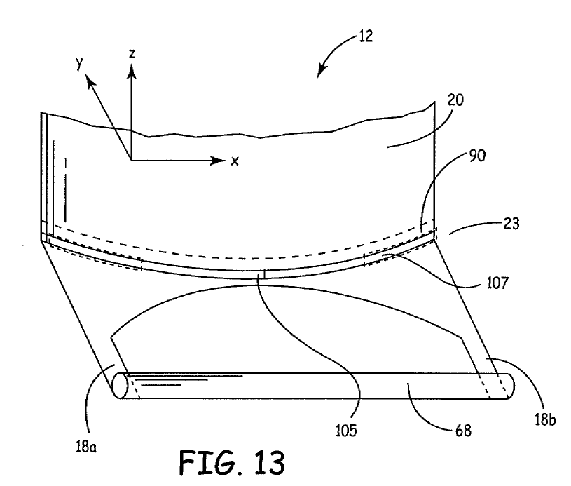

When it is given a flexed, curved shape, the base strip 90 then imparts a curve on the sheet 20. As depicted in FIGS. 12-13, which include x-y-z axes imposed on the figures, the stretchable leader 21 is stretched in different amounts about the z-axis, in the x-y plane, depending on the portion of the leader 21. For example, when the base strip 90 is given a flexed, curved shape, the leader material located between the first base strip end 92 and first retractor end 72 (labeled as d1), and the leader material located between the second base strip end 94 and the second retractor end 74 (labeled as d3) are stretched and stressed more along the y-axis direction than the leader material between the base strip center 96 and the retractor center 75 (labeled as d2). By using stretchable material to construct the leader 21, the leader 21 absorbs and deflection and stress created by the flexed, curved base strip 90 and the sheet 20 remains largely unaffected. This inhibits the curved base strip 90 from creating any kinks or distortions on the sheet 20. The stretchable material can extend across the entire width of the leader and for appropriate compensation of the stresses; the length of the leader material can appropriately be in a “concave” curve facing the erected banner as shown by the junction 23 between the graphic display portion of the banner and the leader portion. Alternatively, as depicted in FIG. 13, the leader 21 can comprise a two leader portions, 18a, 18b. In some embodiments, it is optional to construct the leader portions using a stretchable material. The sheet 20 can be constructed using a stretchable material. The leader 18 can be optional in this configuration.

As illustrated in FIG. 12, the flexible base strip can be permanently within the banner, such as by being sewn in or laminated therein. In such a case, it would be wound up on the core when the banner is retracted. FIG. 13 shows an alternative resiliently flexible rod 105 instead of the flexible strip, placed in a pair of pockets 107 in the banner. Such pockets can be configured to impart a stress to an otherwise straight rod to provide a curvature. For example, the distance between in inside ends of the pair of pockets can be less than the length of the unflexed rod, whereby placement of the rod in the pockets imparts the curvature to the rod. Such a resiliently flexible rod can also be used at the top of the banner for providing curvature there.

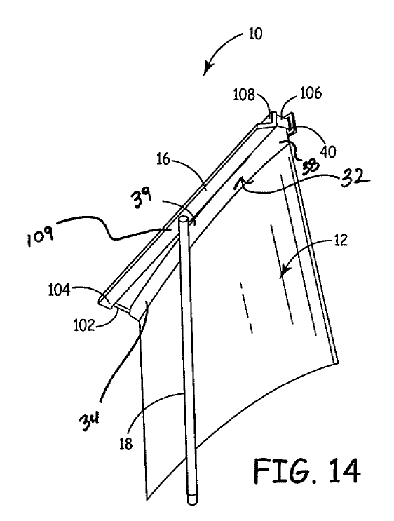

As depicted in FIG. 14, the retractable banner stand 10 can comprise a first header spacer 102 hingedly connected to a first mast end 104 and a second header spacer 106 hingedly connected to a second mast end 108. When the banner 12 is in a fully retracted position, the spacers 102, 106 can be folded inward towards a position intermediate the first mast end 104 and second mast end 108 so that the header spacers 102, 106 abut the cross member 16. When the header spacers 102, 106 are in this position, the top strip 32 remains unstressed and is in a substantially unflexed position.

When the banner 12 is in a fully dispensed position, a header center 39 is connected to a mast center 109 using a hook, snap, rivet, or similar means. In order to connect the header center 39 to the mast center 109, there can be a cutout in the pocket (not depicted) providing access to the header center 39. In addition, once the top strip 32 is connected to the cross member 16, the header spacers 102, 106 can be hinged outward so that they are perpendicular with the cross member 16. Once the header spacers 102, 106 are in this position, the first header spacer 102 engages a third eyelet (not depicted) located on the first header end 34 and the second base spacer 106 engages an fourth eyelet 40 located on the second header end 38. Because the header center 39 is first connected to the mast center 109, the top strip 32 is then in given a flexed, curved shape or form, as can be seen in FIG. 14.

The top strip 32 can comprise a cross-section with a greater dimension in a first plane and a lesser dimension in a second plane that is perpendicular to the first plane. The greater dimension is at least four times the lesser dimension whereby the top strip 32 is more readily flexible in the plane of the lesser dimension and wherein the plane of the lesser dimension is substantially horizontal when the retractable banner stand 12 is erected into the upright mode. While the top strip 32 has been described as having a greater dimension in a first plane and a lesser dimension in a second plane that is perpendicular to the first plane, the base strip can be a rod, cylinder, or wire.

The cross member can be a rigid form and have the curvature means accomplished by simply utilizing a curved cross member and suitably attaching the top of the banner thereto.

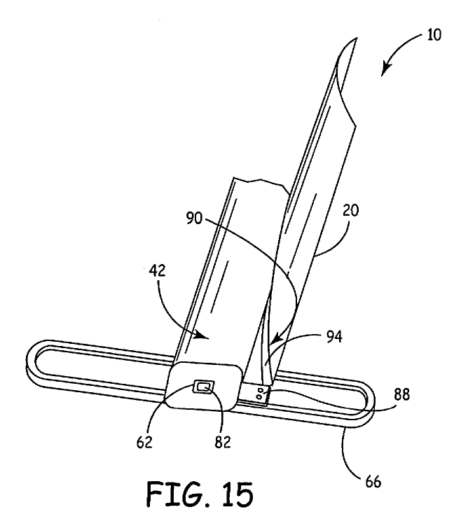

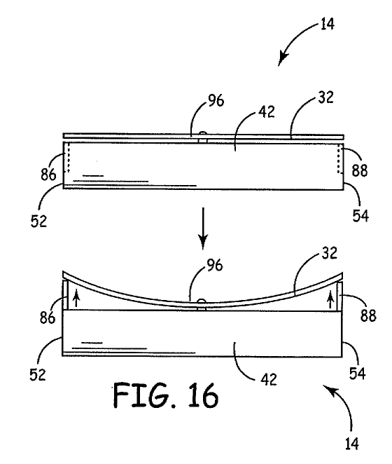

As depicted in FIG. 15, the base spacers 86, 88 can be slidably connected to the housing 42 and fixedly connected to the base strip ends 92, 94. The base spacers 86, 88 are retained within the housing 42 or plates 58, 60 when a user does not wish in impart curvature to the banner 12 or while a user is dispensing the banner 12 from the retractor. When a user desires to impart curvature to the banner 12, the base spacers 86, 88 are released from the retained position and slid out into an extended position. The base spacers 86, 88 can then be locked in their extended position. Once the base spacers 86, 88 are in their extended positions, because the base strip center 96 can be connected to the housing 42, the base strip 90 is given in a flexed, curved shape, as can be seen in FIGS. 15 and 16.

As depicted in FIG. 17, the core 70 is made of a flexible material such that the retractor 68 can be flexed. Once the banner 12 is in a dispensed position, or while the banner 12 is being dispensed, the retractor 68 is flexed such that it imparts curvature to the banner 12. The banner 12 would optionally include the use of a leader. Because the entire retractor width 76 and banner width 22 are being curved, there would not be a significant amount of distortion due to the curvature. However, the banner 20 can be constructed of a stretchable material to compensate for any amounts of stress or distortion on the banner 12.

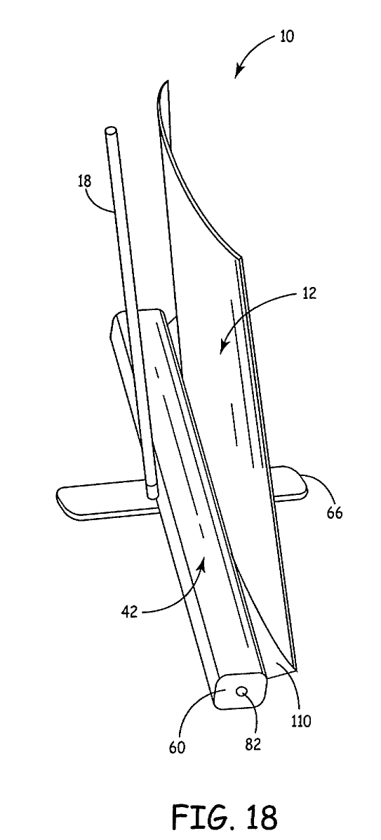

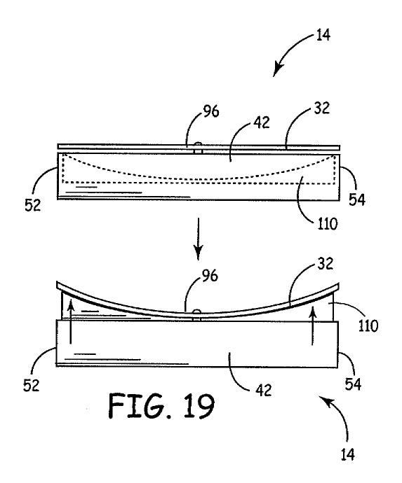

As depicted in FIGS. 18-19, a base form 110 is slidably connected within the housing 42. Once the banner 12 has been dispensed from the retractor 68, the base form 110 can slide out of the housing 42. Once the base form has slid out of the housing, the general shape of the base form 110 is imparted on the banner 12 as it takes the general shape of the base form 110. For example, if the base form 110 has a curved shape, the banner 12 will take a generally curved shape. Alternatively, the base form 110 can be hinged or folded up against the housing 42 until the banner 12 is dispensed from the retractor 68. Once the banner 12 is fully dispensed, the base form 110 can be folded downwardly or upwardly so that it is substantially perpendicular with the housing 42. Once in this position, the general shape of the base form 110 would be imparted on the banner 12 as it takes the general shape of the base form 110.

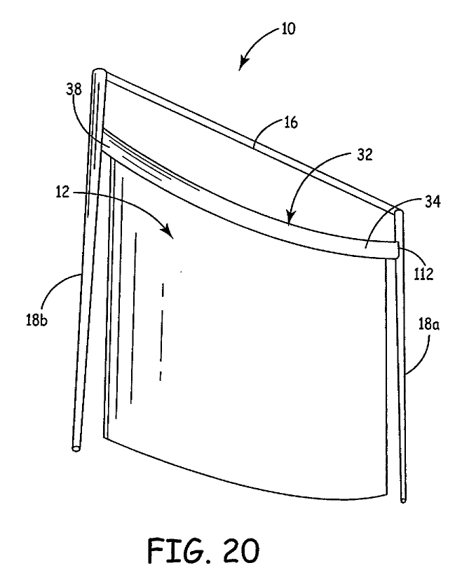

Referring to FIG. 20, in any of the aforementioned embodiments, the top strip 32 can be connected on the outside of the header 28, as opposed to being slidably engaged within a pocket 30 as described in the aforementioned embodiments. Once the banner 12 is dispensed from the retractor 68, the first header end 34 and second header end 38 can slidably engage post slots 112 on a first post 18a and a second post 18b, the posts 18a, 18b being connected to the base 14 and cross member 16. Before the ends header ends 34, 38 can be inserted into the post slots 112, a user would impart a curve to the top strip 32 so that the distance between the header ends 34, 38 would be slightly less than the distance between the posts 18a, 18b. Once the distance between the header ends 34, 38 is slightly less than the distance between the posts 18a, 18b, the header ends 34, 38 can be inserted into the post slots 112. By doing this, the posts 18a, 18b would retain the curvature in the top strip 32 once the header ends 34, 38 are retained.

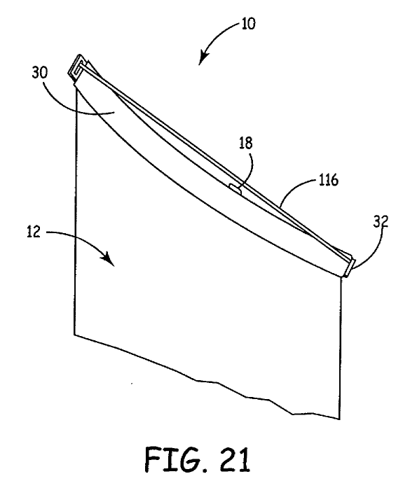

As depicted in FIG. 21, the banner 12 can include a wire 116 connected to the top strip 32. Before the wire 116 is connected to the top strip, the top strip is flexed imparting a curve or bend in the top strip and then the wire 116 is connected to the first header end 34 and second header end 38, thus preserving the curve in the top strip 32. Once the banner 12 has been dispensed from the retractor 68, the header 28 or top strip 32 of the banner 12 can be connected to the mast center 109 using a hook, snap, rivet, or other suitable means.

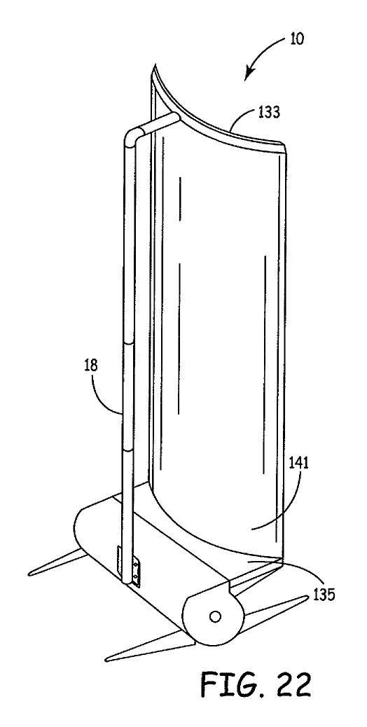

Referring to FIG. 22, the mechanism for providing curvature to the banner comprises rigid curved form 133 can be configured as the cross bar 133 and a rigid lower curved form 135. Both of these components, as well as the mast 18 can be separable from the other components and/or dissassembleable. The top 137 of the banner can be connected using attachment mechanisms 139 such as hook and loop material, magnetic strips, snaps, hooks or other known attachment mechanisms. The bottom 141 of the banner remains attached to the retractor mechanism, but can also be suitably secured to the lower curved form such as by magnetic strips or hook and loop material. Stretchable leader material can also be used. The leader material can be more stretchable that the material utilized for the banner.

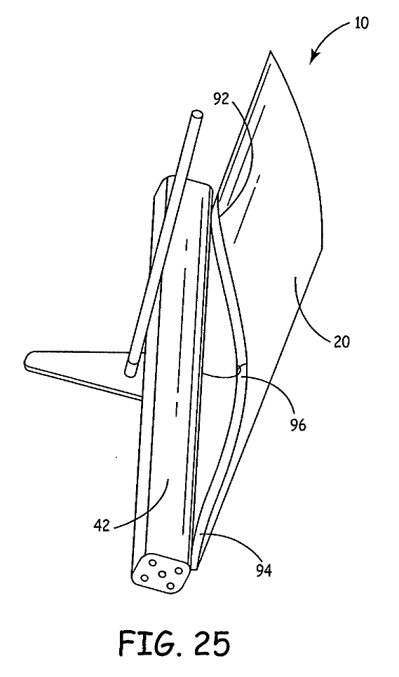

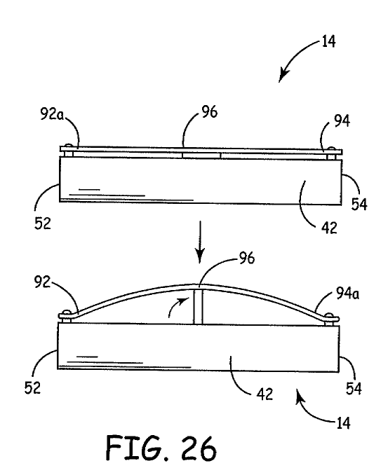

The various embodiments of the retractable banner stand have been described as having a generally concave shape when viewing the banner from the front. Those of ordinary skill in the art would appreciate that the various embodiments can be easily modified so that the retractable banner stand has a generally convex shape when viewing the banner from the front. An example of such a banner can be seen in FIG. 25-26. The first strip end 92 and second strip end 94 of the base strip 90 can be connected to the front 48 of the housing 42 while the base strip center 96 remains unconnected. Any number of means, including those described in the present application, can be used to impart a curve on the base strip 90.

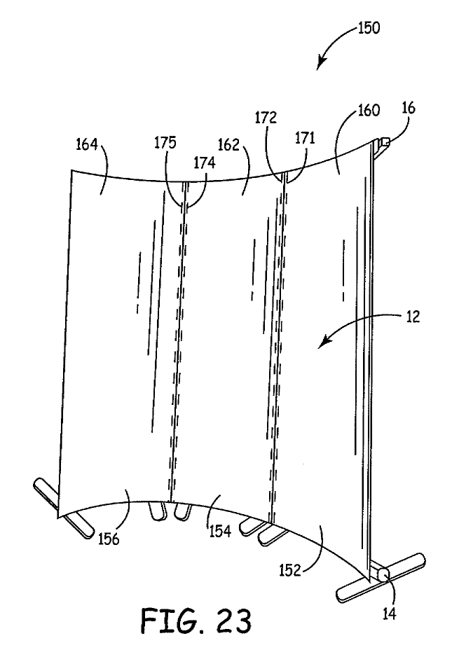

Referring to FIG. 23 a trade show display 150 comprises first, second and third retractable banner stand 152, 154, 156 abutting against and/or connected together. The three banner stands are in the erected upright mode as illustrated and the collapsed transport mode as previously described. The three stands have respective first, second, and third banners 160, 162, 164 and suitable means for providing curvature to the banners. The adjacent banner edges 171, 172, 174, 175 can be connected by magnetic strips in the respective banner edges or other connection means such as hook and loop material or the like. See International Publication WO 01/35381, disclosing connecting adjacent banners or screens. Said Publication is incorporated herein by reference.

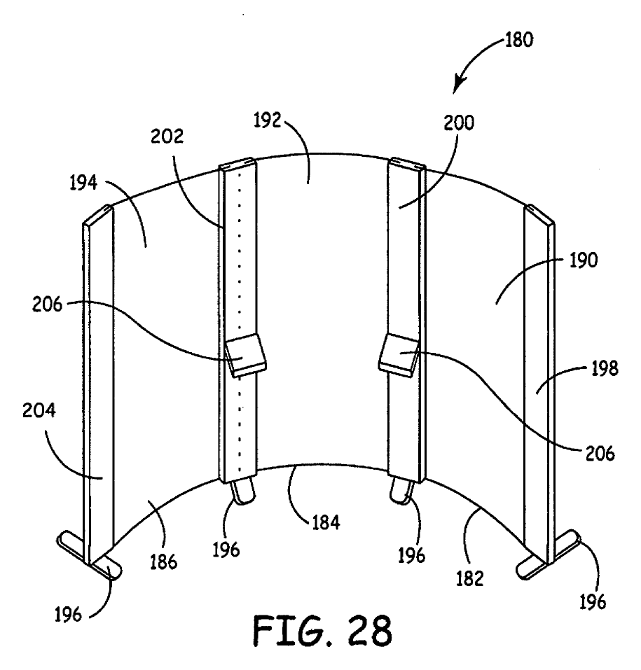

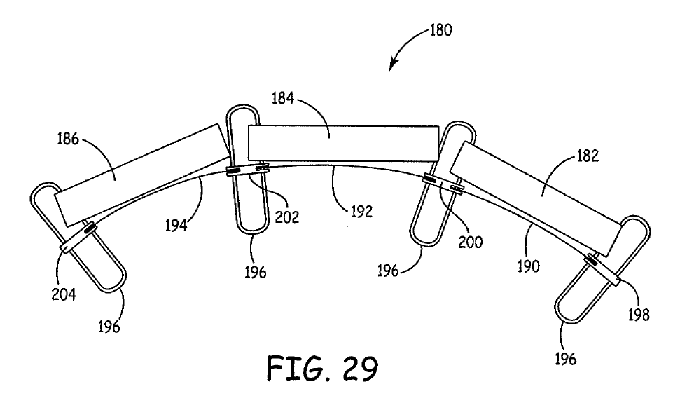

If two or more of the retractable banner stands with curvature means are placed adjacent to one another, the banner stands can be connected so that the series of banners create a semicircle or arc. By doing so, the display can be continuous and smooth from one display banner to the next adjacent banner. Alternatively, one or more retractable banner stands with curvature means can be used in conjunction with one or more retractable banner stands without curvature means to create different shaped configurations. Referring to FIGS. 28-29, a tradeshow display 180 comprises a first, second and third retractable banner stand 182, 184, 186 abutting against and/or connected together. The three banner stands are in the erected upright mode as illustrated and the collapsed transport mode as previously described. The three stands have respective first, second, and third banners 190, 192, 194 and suitable means for providing curvature to the banners. Feet 196 are shared between adjacent retractable banner stands 10. Posts 198, 200, 202, 204 are then placed on the feet 196 shared between adjacent retractable banner stands. These posts 198, 200, 202, 204 then hide or cover the edges of the banner 190, 192, 194 and also offer product-holding capacity on a product-storing member 206. The product-storing member 206 can hold samples, brochures, business cards, flyers, or any other promotional materials. The product-holding member 206 can be connected to a post, which is then connected to the housing 42, the at least one foot 66 or the feet 196, or to any other portion of the retractable banner stand 10.

Posts 198, 200, 202, 204 are depicted as having a generally H-shaped cross section. However, posts 198, 200, 202, 204 can have round, square, rectangular, octagonal, or another geometric cross sectional shapes.

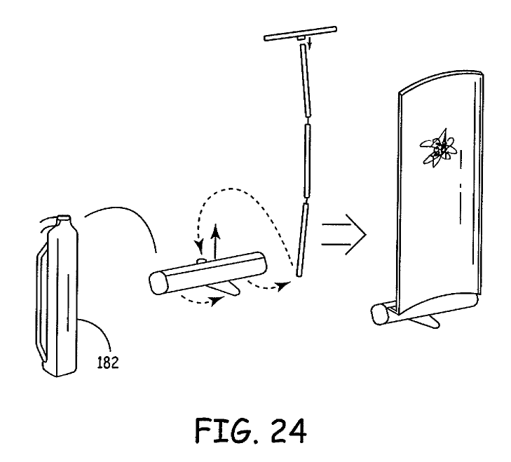

Referring to FIG. 24, when the retractable banner stand 10 is in a fully retracted or collapsed transport mode, it can be placed into a carrying case or bag 182 for ease of storage and transport from a storage area to the place where it is to be dispensed and used for display. Basic steps in erecting a banner stand are described as follows. At the place the stand is to be set-up, the housing is removed from the bag or case; the mast, can be lodged within a recess or nesting area of the housing is removed and assembled; the foot or feet on the housing are pivoted to provide a secure base; the mast is inserted into a receiving hole on the housing; the banner is extended and attached at the top of the mast; the curvature means is actuated or attached. If there are two or more stands, they are appropriately positioned adjacent one another and attached such as by the edges of the banners and/or other suitable locations. Although various exemplary embodiments of the retractable banner stand have been described herein, numerous changes and variations can be made. For example, the means for providing curvature can provide a complex curve such as an S-shape in certain embodiments.

Co-pending U.S. patent application Ser. No. 11/000,855, entitled “Curved Retractable Banner Stand,” filed Dec. 1, 2004, incorporated herein by reference in its entirety, depicts and describes a banner stand including a mechanism to impart a smooth curve to the banner, such that a single banner stand can have the aforementioned depth and welcoming feel. Two or more curved banner stands can be arranged in series to create a larger curved display. When these banner stands are in an upright open position and the curve is imparted thereto, the banner can bunch up towards the middle of the one or more curved forms. This can occur due to, for example, the stretched banner material desiring to return to its relaxed and/or unstretched state. When this occurs, the overall visual appeal of the banner stand can be lessened and the graphics can be less than fully viewable. Users can attempt to readjust the banner, but this can take time and the banner can merely return to the bunched up state over time. To counter such a tendency, a retaining, friction, or anti-slip member or portion can be included on the retractable banner stand.

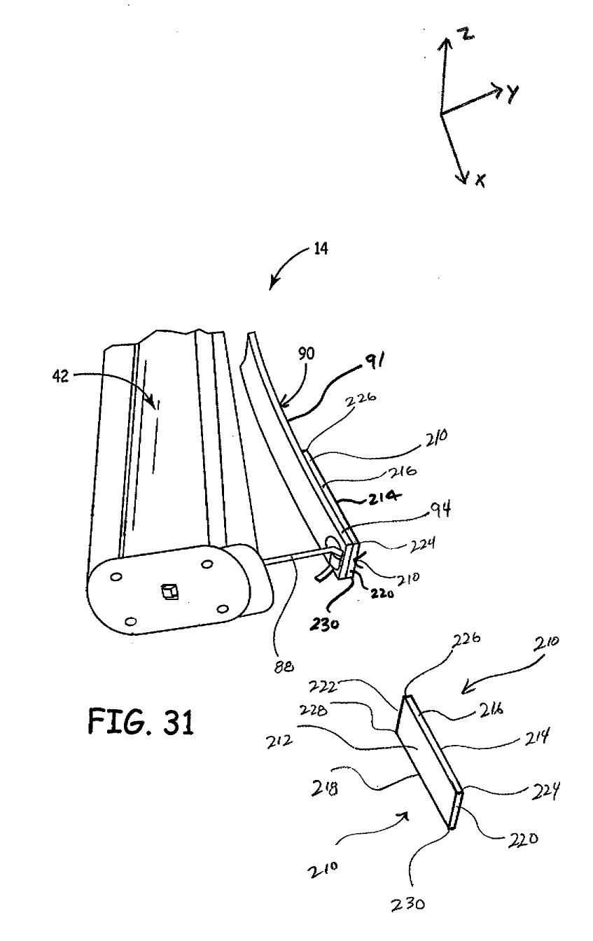

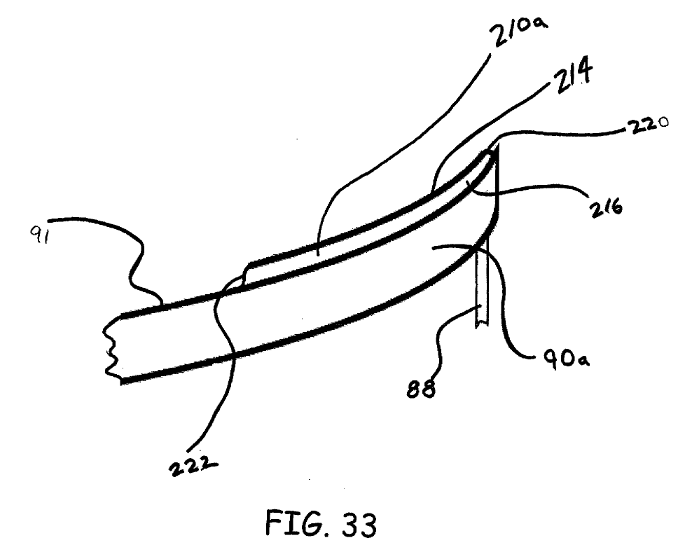

For example, referring to FIGS. 31-34, a retaining member or portion 210 can be presented lengthwise on at least one of the curved elongate forms, such as curved portion of the base strip 90 (depicted) or the top strip. A retaining portion 210 can also be coupled to a major surface (such as the inside surface) of the banner 12 proximate the base strip 90 and/or the top strip.

Referring to FIG. 31, in an embodiment, retaining member 210 comprises a first surface 212, a second opposed surface 214, a top edge 216 and an opposed bottom edge 218, a first side edge 220, a second opposed side edge 222, and linear or rounded corners 224, 226, 228, 230 at junctions of first and second side edges 220, 222 and top and bottom edges 16, 218. Those skilled in the art will recognize that other shapes and configurations can be used for retaining member 210.

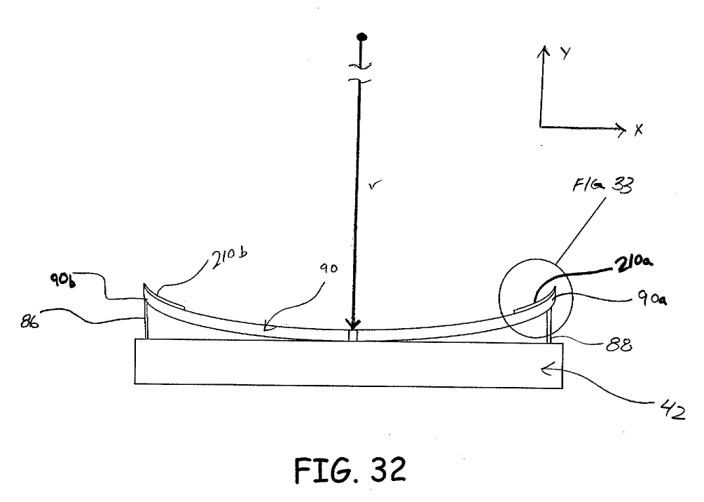

Referring to FIG. 32, the curved form 90 can comprise a first end 90a and a second end 90b. In this embodiment, the retaining portion 210 comprises a first portion 210a and a second portion 210b. The first portion 210a can be operably coupled proximate the first end 90a and the second portion 210b can be coupled proximate the second end 90b. Those skilled in the art will recognize that the one or more retaining portions 210a, 210b can be coupled to or presented on other portions of the base or top strip, such as the top, bottom, inside, and/or outside surfaces, and corners. Such positioning can be selected to inhibit any damage to the screen material, such as LYCRA®.

The retaining portion 210 is depicted as being coupled with the base strip 90 in FIGS. 31-34. Such coupling of the retaining portion 210 can be accomplished by gluing, taping using double-sided tap, stitching, or otherwise coupling the retaining member 210 to the base strip 90 or top strip. Those skilled in the art will recognize that other materials, such as silicon liquid or gel or polyester; thermoplastic polymers, air curing polymers, urethane, epoxies, and any combinations thereof can be used for the retaining portion. For example, a silicon-based liquid can be put on in liquid form and enabled to cure, leaving a portion with a surface having a high coefficient of friction. Generally stated, non-skid pads of various materials can be utilized. Two sided adhesive strips could be utilized as well in some embodiments.

The retaining portion 210 can comprise, for example, a strip of sueded material or a hook and loop portion of a hook and loop type fastener. The retaining portion 210 can be constructed of polyester and can be sueded on the operable surface 214 thereof. In an embodiment, the retaining portion 210 can specifically be gaming suede, such as is used on casino game tables.

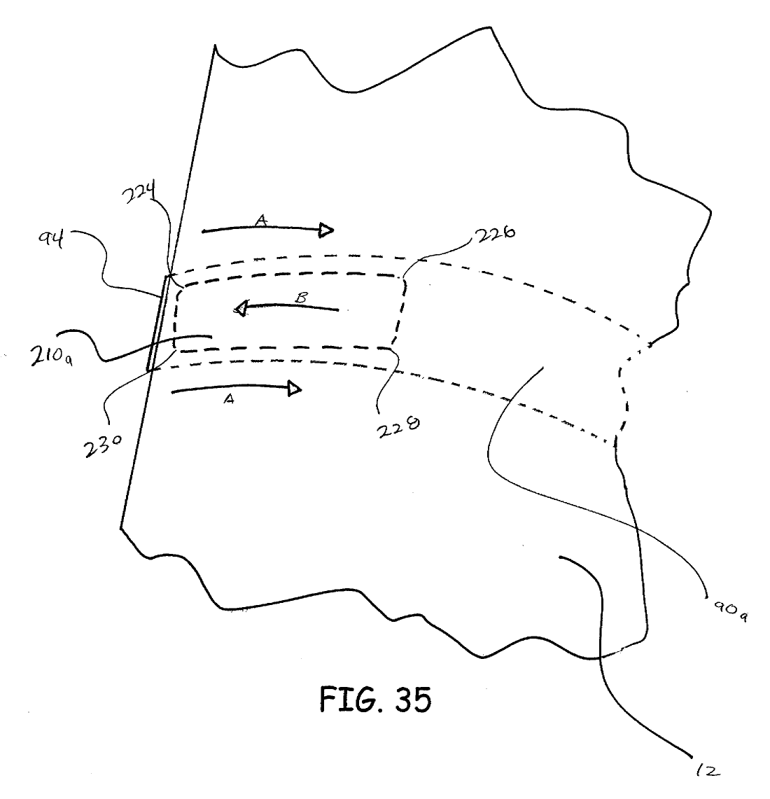

Referring to FIG. 35, the corners 224, 226, 228, 230 of the retaining portion 210 can be rounded to inhibit or prevent peeling of the retaining portion 210 from the curved form. As depicted, the retaining portion 210 can be dimensioned such that it is slightly less in width (dimension if first plane, as described above) than that of the curved form. This dimensioning can inhibit any damage to the screen material or graphic.

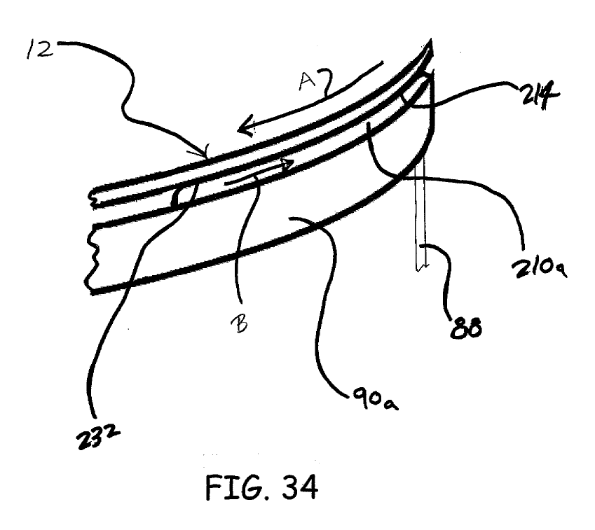

Referring to FIGS. 34 and 35, close-up views of the retaining portion 210 coupled with the base strip 90 are depicted. In these views, the inner surface 232 of banner 12 is depicted as being in operable communication with the base strip, and specifically the operable surface 214 of the retaining portion 210. Arrow “A” represents an inward direction that the banner 12 can tend to move along when in a stretched and/or open configuration and desiring to return to a relaxed, unstretched state. When in engagement with the banner 12, the retaining portion can comprise a sufficient coefficient of friction to outwardly retain the banner 12 towards the end(s) 94 of the base strip 90 or top strip. Arrow “B” represents the direction in which the retaining portion 210 will counter the movement of the banner in direction “A.”

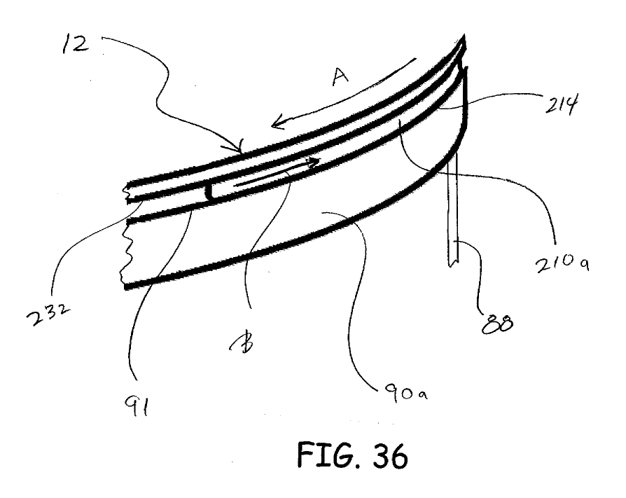

Referring to FIG. 36, in another embodiment, the retaining portion 210 can be coupled to an inner surface 232 of the banner 12. In this configuration, the operable surface 214 of the retaining portion 210 can be operable with the curved surface 91 of the base strip 90. Again, arrow “A” represents the inward direction that the banner 12 can tend to move along when in a stretched and/or open configuration and arrow “B” represents the direction in which the retaining portion 210 will counter the movement of the banner 12 in direction “A.”

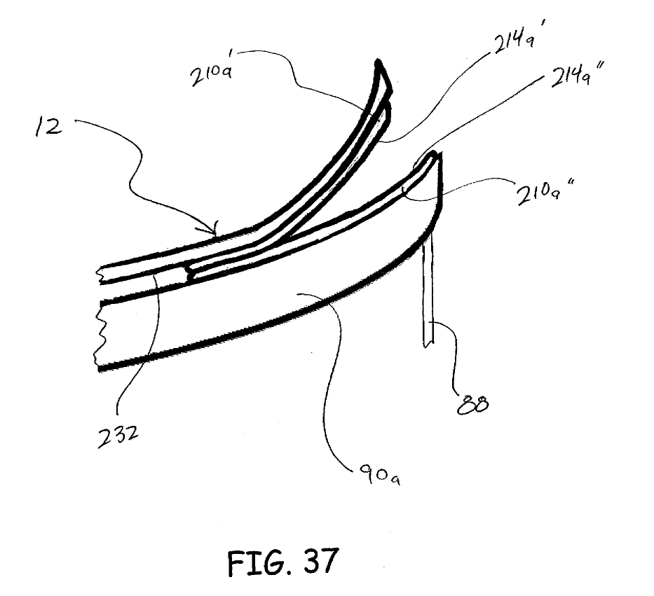

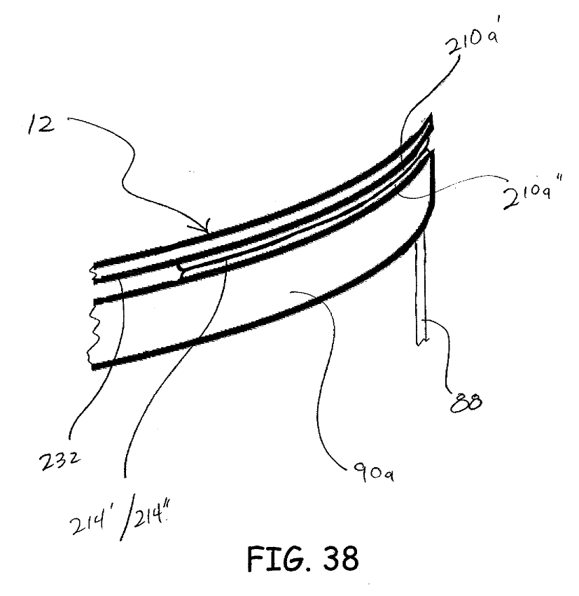

Referring to FIGS. 37 and 38, the retaining portion 210 can comprise a first half 210a′ coupled with the curved form 90 and a second half 210a′ coupled with an inner surface 232 of the banner 12. In this configuration, respective operable surfaces 214′, 214″ the first and second halves 210a′, 210a″ of the retaining portion 210a can be in selective communication with one another when the banner 12 is in an open, curved configuration. The first and second halves 210a′, 210a″ can comprise, for example, a hook and loop mechanism, respectively or vice versa.

In use, once the banner 12 has been retracted such that it is in an open configuration, a curved form 90 can be used to impart curvature on the banner 12, the curve having a radius r thereto (FIG. 32). When the banner 12 is in this open, curved configuration, the retaining portion 210 on the curved form can inhibit or prevent any bunching of the banner material. This can be accomplished due to the retaining portion 210 having a coefficient of friction relative to the banner inhibiting the banner from sliding or moving relative to the curved form 90. By so doing, the overall visual appeal of the banner stand can be maintained and the graphics remain fully viewable. Also, by so doing, users do not have to readjust the banner, which otherwise can take valuable time during a tradeshow or other event.

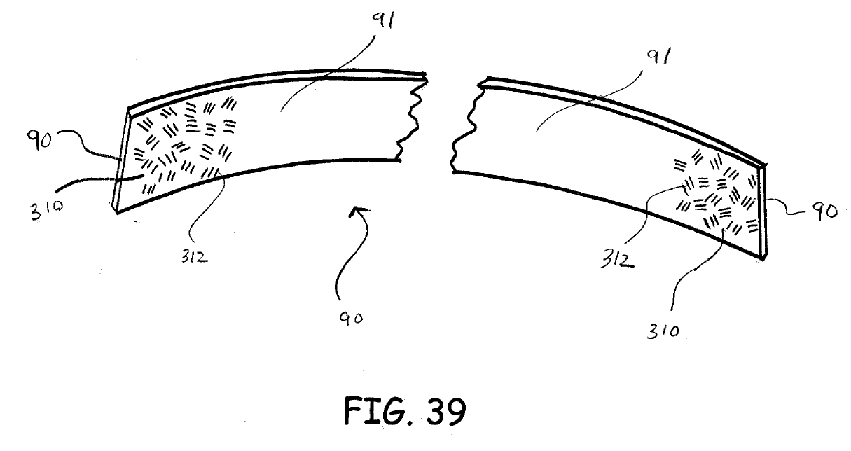

Referring to FIG. 39, in an embodiment, curved surface 91 of the base strip 90 can include a retaining member 310 comprising projections 312 presented with the curved surface 91, or otherwise comprising roughened or modified portions of the curved surface 91 at one or more locations thereon. Such retaining member 310 can provide a mechanism on the curved form 90 to inhibit or prevent any bunching of the banner material. This can be accomplished due to the projections or roughened or modified surface 310 of the curved form 91 having a coefficient of friction relative to the banner inhibiting the banner from sliding or moving relative to the curved form.

Pre-exiting banner stands not having a retaining portion on a curved form thereof can be retrofitted by adhering or otherwise coupling, adhering, or presenting a retaining portion on a curved form of a banner stand.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein.

1. A banner stand having an upright mode and a collapsed mode, said banner stand comprising:
a banner having generally opposed major surfaces, said banner having graphics presented with at least one of said major surfaces;
a base and a post extending upwardly from said base; said post operably supporting said banner when said banner is in an upright mode;
a curved form having a curved surface for operably supporting said banner in a curved shape; and
a retaining portion presented with said curved surface, said retaining portion presenting an operable surface engageable with at least one of said major surfaces to retain said banner in said curved shape with frictional engagement, said operable surface providing a coefficient of friction between said banner and said operable surface that is greater than a coefficient of friction between the banner and a comparable curved surface without the retaining portion.

2. The stand of claim 1, wherein said curved form is selectively changeable from a first configuration into a curved configuration to selectively impart said curved shape to said banner when said banner is in said upright mode.

3. The stand of claim 1, wherein said base comprises a housing and a core for winding said banner thereupon when in a collapsed mode and a retracting mechanism for unwinding and winding said banner with respect to said core.

4. The stand of claim 1, wherein said retaining portion is operably coupled to said curved surface.

5. The stand of claim 1, wherein said retaining portion is formed into said curved surface.

6. The stand of claim 1, wherein said retaining portion is presented with less than the entire curved surface.

7. The stand of claim 1, wherein said retaining portion comprises suede.

8. The stand of claim 1, wherein said curved form comprises a first end and a second end and said retaining portion comprises a first portion and a second portion, said first portion presented proximate said first end and said second portion presented proximate said second end.

9. The stand of claim 1, further comprising a second curved form having a second curved surface; and
a second retaining portion presented with said second curved surface, said second retaining portion engageable with at least one of said major surfaces to operably support said banner in said curved shape.

10. A method of providing a banner and retaining the banner in an open, curved configuration comprising:
providing a banner having generally opposed major surfaces and being formed of a flexible sheet;
providing a curved form having a curved surface and a retaining member presented with the curved surface, said retaining member having an operable surface providing a coefficient of friction between said banner and said operable surface that is greater than a coefficient of friction between the banner and the curved surface without the retaining member; and
utilizing the curved form to support the banner in an open, curved configuration, wherein the operable surface frictionally engages with at least one of the major surfaces of the banner to retain the banner in the open, curved configuration.

11. The method of claim 10, further comprising:
providing a base and a post selectively coupleable with the base and extendable therefrom;
providing a cross member operably coupleable with the post for supporting the banner in an upright position; and
coupling the post to the base and coupling the cross member to the post, such that the cross member can support the banner in the upright position.

12. The method of claim 11, further comprising:
providing a housing comprising a core for winding the banner thereupon and a retracting mechanism for unwinding and winding the banner with respect to the core; and
unwinding the banner with respect to the core prior to retaining the banner in the upright position.

13. The method of claim 10, wherein the retaining member is presented on the curved surface by adhering the retaining member thereto.

14. The method of claim 10, wherein said retaining member is presented with less than the entire curved surface.

15. A tradeshow display comprising:
a sheet having generally opposed major surfaces;
curved means having a curved surface for selectively supporting the sheet in an open, curved configuration; and
retaining means presented with the curved surface, the retaining means having an operable surface providing a coefficient of friction between said sheet and said operable surface that is greater than a coefficient of friction between the sheet and the curved means without retaining means, said operable surface engageable with at least one of the major surfaces to retain the banner in the open, curved configuration.

16. The display of claim 15, wherein the retaining means comprises suede and includes a coupling surface generally opposed the operable surface, the retaining member being operably adhered to the curved surface at the coupling surface.

17. The display of claim 15, wherein the curved means comprises a first end and a second end and the retaining means comprises a first portion and a second portion, the first portion presented proximate the first end and the second portion presented proximate the second end.

18. The display of claim 15, wherein said curved form is selectively changeable from a first configuration into a curved configuration to selectively impart a curve to said banner when said banner is in said upright open position.

19. The display of claim 15, wherein said retaining portion is operably coupled to said curved surface.

20. The display of claim 15, wherein said retaining portion is presented with less than the entire curved surface.
